(19) United States
(12) Patent Application Publication
(10) Pub. No.: US 2020/0198565 A1
(43) Pub. Date: Jun. 25, 2020

(54) FRONT PART OF THE BODY OF A VEHICLE, COMPRISING SIDE REINFORCEMENTS IN CASE OF A FRONTAL IMPACT WITH ANOTHER VEHICLE

(71) Applicant: PSA AUTOMOBILES SA, Poissy (FR)

(72) Inventor: Marc PERU, CHATENAY MALABRY (FR)

(21) Appl. No.: 16/615,754

(22) PCT Filed: Apr. 25, 2018
(86) PCT No.: PCT/FR2018/051053

§ 371 Date: Nov. 21, 2019

(30) Foreign Application Priority Data
May 29, 2017 (FR) 1754670

(51) Int. Cl. B60R 19/18; B60R 19/26

(52) U.S. Cl. CPC B60R 19/18; B60R 19/26; B60R 2019/247; B60R 2019/186; B60R 2019/1806

(57) ABSTRACT

Front part of the body of a vehicle, comprising side reinforcements in case of a frontal impact with another vehicle. Each of the ends of the front beam (1) comprises a rigid reinforcing end piece (4) secured to, and extending from, the front beam (1) and being curved towards the rear of the vehicle, the reinforcing end piece (4) being covered with a damping cover (6).

### CROSS-REFERENCE TO RELATED APPLICATIONS

This application is the US National Stage under 35 USC § 371 of International Application No. PCT/FR2018/051053, filed 25 Apr. 2018 which claims priority to French Application No. 1754670 filed 29 May 2017, both of which are incorporated herein by reference.

### BACKGROUND

This invention relates to a front part of the body of a motor vehicle.

Automakers are concerned about reducing the cost of repairing vehicles in the event of an “urban” impact, that is, at a slow speed.

The behavior of motor vehicles in this impact situation is regulated and tested through a new European frontal impact protocol called “frontal impact compatibility”.

A known front part of the body of a motor vehicle comprises a transverse metal front beam whose two opposite ends are each connected to the front end of a shock absorber the rear end of which is connected to the front of one of the two side sills of the vehicle body.

FIG. 1 partially shows in perspective one side of the body of a vehicle according to the prior art and comprising the transverse front bumper beam 1, one of whose two ends is connected to the front end of the shock absorber 2 whose rear end is connected to the front of the corresponding side sill 3 of the body C of the vehicle.

FIG. 2 is a top view of the frontal impact test of the above-mentioned new protocol according to which the vehicle V is projected at low speed against a deformable barrier B onboard a mobile carriage CM representative of a second vehicle whose front side is represented by the deformable barrier B.

Success in this test depends on not “assaulting” the barrier B, that is to say not to tear or pierce the barrier B during the frontal impact of the vehicle V with the deformable barrier B offset from the axis of movement of the vehicle V.

As shown in FIG. 1, the ends of the front beam 1 each end substantially at a right angle to the corresponding shock absorber 2, and the ends comprise sharp edges 1a which may tear the barrier B during the frontal impact test of FIG. 2.

To satisfy the new frontal impact protocol, a new front bumper beam of the front part of a motor vehicle with sufficiently stiff overhangs on the sides of the front beam is known as is the reinforcement of the front beam to limit its protection to the center. However, this known solution results in a heavier front beam and a larger section in order for the beam to be sufficiently stiff on the sides. In addition, this known solution does not completely solve the problem of tearing of the barrier B and, consequently, of the bumper skin of the vehicle represented by the movable carriage CM and the barrier B because the stiffness of a front beam is not always easy to adjust on the sides.

U.S. Pat. No. 9,073,496 discloses a front bumper beam structure of a motor vehicle, with reinforcements inserted into the front cross-beam and made of transverse steel tubes extending fully along this cross-beam.

However, such a known front bumper beam structure of a vehicle does not at all address the problem of tearing a deformable barrier during the frontal impact test with a vehicle according to the new frontal impact protocol previously mentioned.

### SUMMARY

This vehicle front part aims to overcome the above disadvantages of the prior art.

This purpose is achieved by virtue of a front part of the body of a vehicle, in particular an automobile, comprising a transverse front bumper beam the two opposite ends of which are each connected to the front end of a shock absorber, the rear end of which is connected to the front of one of the two side sills of the body, wherein each of the ends of the front beam comprises a rigid reinforcing tip integral with the front beam as an extension thereof and which has a curvature directed towards the rear of the vehicle and in that the reinforcing tip is clad in a damping shell.

Advantageously, the reinforcing tip is fastened in a corresponding end portion of the front beam by welding or gluing.

Alternatively, the reinforcing tip is fastened in the corresponding end portion of the front beam by a foam expanded in this end portion.

Advantageously, the damping shell is fastened by gluing around the reinforcing tip and, where appropriate, by gluing at its connection to the end of the front beam.

Preferably, the reinforcing tip comprises two parallel and superimposed metallic tubes of circular or rectangular sections respectively housed in two internal compartments of the end part of the front beam.

Advantageously, the damping shell is a profile made of a composite material.

The rear of each shock absorber has a plate which is itself fastened to a plate, which in turn is fastened to the front of the corresponding side sill. A gusset is fastened between the two plates and a box made of a composite material is fastened at right angles between the gusset and the end of the front beam.

### DESCRIPTION OF THE FIGURES

The vehicle front part will be better understood, and other objectives, features, details and advantages thereof will appear more clearly in the explanatory description which follows, made in reference to the accompanying drawings provided solely by way of example illustrating an embodiment of the vehicle front part and in which:

FIG. 1 is a partial perspective view of a front portion of a motor vehicle according to the prior art described above;

FIG. 2 shows a frontal impact test of a vehicle against a deformable barrier according to the new front impact protocol described above;

FIG. 3 is a partial view in perspective of the front part of the body of a motor vehicle, the front beam of which includes a reinforcing tip;

FIG. 4 is an enlarged view of the circled part IV of FIG. 3;

FIG. 5 is a top view along arrow V of FIG. 3;

FIG. 6 is a partial perspective view, similar to that of FIG. 3 and showing a damping shell over the reinforcing tip;

FIG. 7 is a partial enlarged perspective view along the arrow VII of FIG. 6;

FIG. 8 is a perspective view showing the assembly of reinforcing tip and damping shell;

FIG. 9 is a partial enlarged perspective view of the front portion according to an alternative embodiment, showing the addition of a composite square bracket box between a gusset and the end of the front beam with reinforcing tip;

FIG. 10 is a partial perspective view showing the box of FIG. 9 located between the gusset and the end of the front beam provided with the damping shell over the reinforcement tip; and

FIG. 11 is an enlarged perspective view of the box shown in FIGS. 9 and 10.

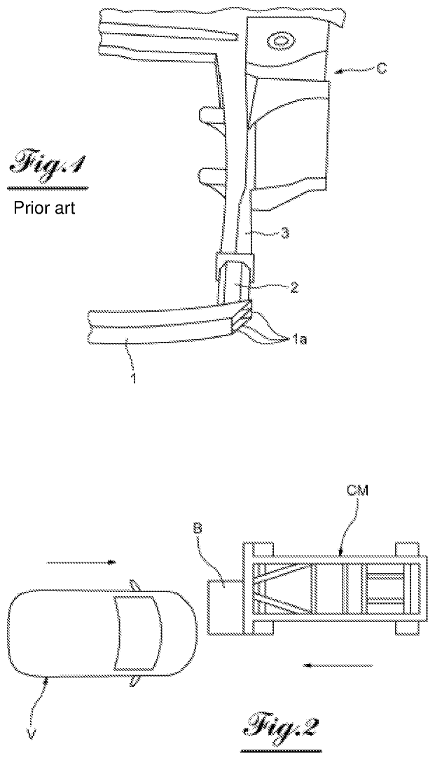

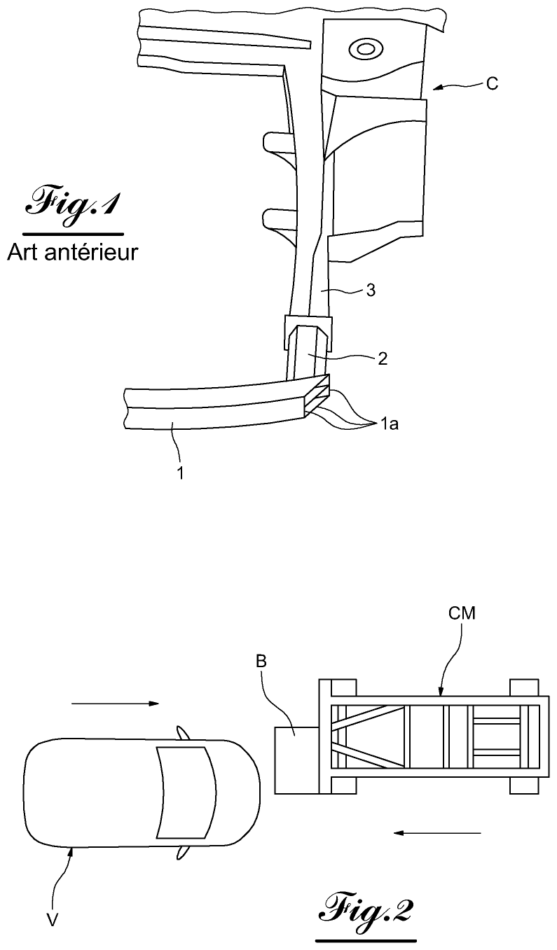

### DETAILED DESCRIPTION

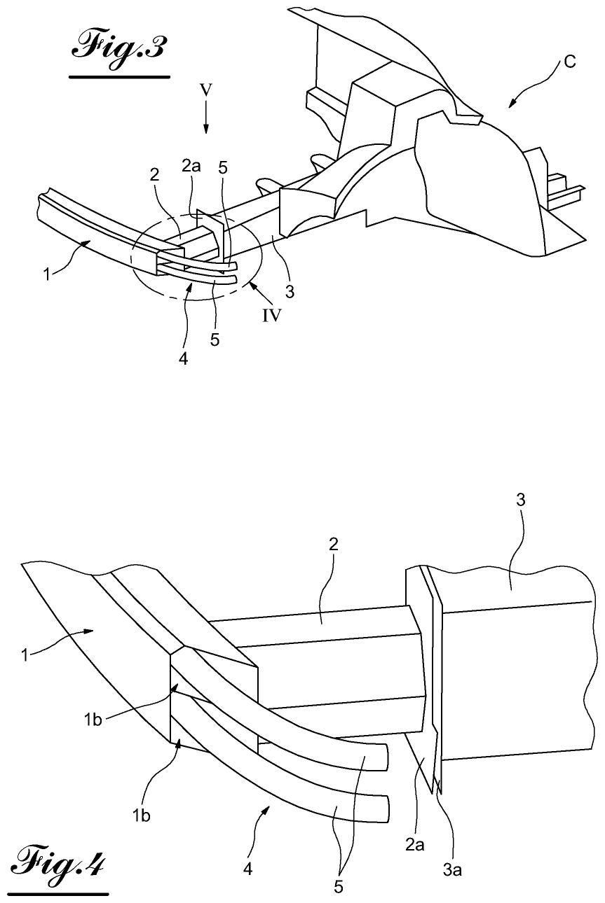

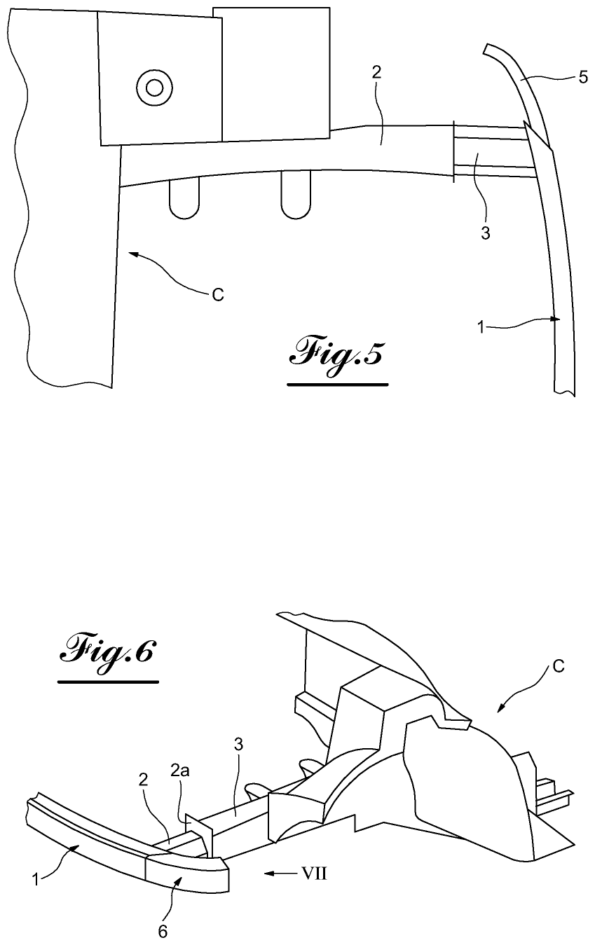

FIGS. 3 to 6 show portions of a front portion of the body C of a motor vehicle comprising a metal front bumper beam 1 extending transversely from the vehicle. One end of the front bumper beam is connected to the front end of a shock absorber 2, the rear end of which is connected to the front of one of the two side sills 3 of the body C.

Although not shown, the opposite end of the front beam 1 is connected to the front end of the other shock absorber, the rear end of which is connected to the front of the other of the two side sills 3 of the box C.

The two shock absorbers 2 are located in the extension respectively of the two side sills 3.

In addition, the two shock absorbers 2 and the two side sills 3 of the body C are arranged symmetrically to the median vertical plane of the motor vehicle.

The front portion of body C further comprises a rigid reinforcement tip 4 integral to each end of the front beam 1 as an extension thereof and which has a curvature directed towards the rear of the vehicle so as to cover the side of the front beam 1.

The rear end of each shock absorber 2 has a plate 2a which is fastened to a plate 3a which itself is fastened to the front end of the corresponding side sill 3. The fastening of the two plates 2a and 3a to each other can be accomplished using bolts, not shown.

Preferably, the reinforcing tip 4 is made up of two parallel metallic tubes 5, for example made of steel, which are superimposed, each being bent towards the rear of the vehicle, projecting beyond the vertical plane containing the shock absorber 2 and the corresponding side sill 3.

The two curved tubes 5 are housed by their end parts respectively in two internal elongated compartments 1b formed in the hollow part of the front beam 1 and are fixed in these two compartments by suitable means.

For example, the two reinforcing tubes 5 can be fastened by welding in the compartments 1b of the front beam 1 by laser or welding beads or can be fastened by gluing with a structural adhesive or a mastic, especially in the case where the front beam 1 would have a square cross section. Such a fastening method must be provided in the case where the front beam 1 is made up of a new part (redesigned) so that the reinforcing tubes 5 at each end of the front beam 1 will be assembled during the production of the beam itself.

In the case where a pre-existing front beam 1 is reused (i.e., retrofitted with the reinforcing tubes 5), the reinforcing tubes 5 are inserted into the corresponding end portions of the front beam 1 at the end of assembly of the vehicle and these tubes can be maintained in the end parts of the front beam 1 by injecting a suitable dose of expanding foam into each compartment 1b of the beam, which foam, once expanded, will solidify the reinforcing tubes 5 in the corresponding hollow end parts of the front beam 1.

FIGS. 3 to 5 show that each of the reinforcing tubes 5 has a circular cross section, but they may have a rectangular or square cross section that will allow them to adjust themselves in their respective internal compartments of matching shape 1b of the front beam 1, being of course integrated into the end parts of this beam by the aforementioned fastening means.

It is nevertheless preferable to make the two reinforcing tubes 5 of circular section which do not have a sharp edge that can be “aggressive” vis-à-vis the barrier B, which represents another vehicle, as shown in FIG. 1.

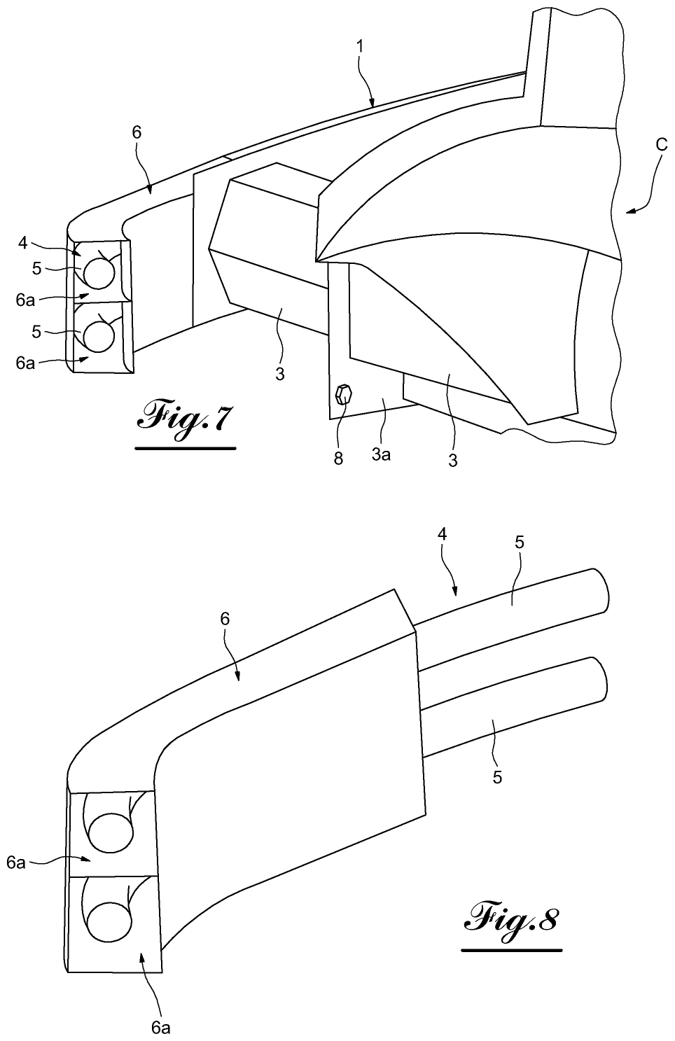

For the purpose of damping upon contact of either side of the front beam 1 with the barrier B, a damping shell 6 is provided which is preferably made up of a profile of composite material, as is apparent from FIGS. 6 to 8.

The damping shell 6 has a hollow body comprising two parallel internal compartments 6a in which are respectively housed the two reinforcing tubes 5 of the corresponding end of the front beam 1. Thus, each damping shell 6 matches the curved shape of the two corresponding reinforcing tubes 5 and can be fastened around the reinforcing tubes 5, for example by injecting an expanding foam into each compartment 6a of the damping shell 6 to secure the two tubes in their respective compartments 6a once the foam has expanded.

Preferably, the composite material of the damping shell 6 is of the short fiber type, making this material inexpensive.

Where appropriate, the damping shell 6 may be fastened, for example by gluing, at its connection portion to the front beam 1 as shown in FIG. 6.

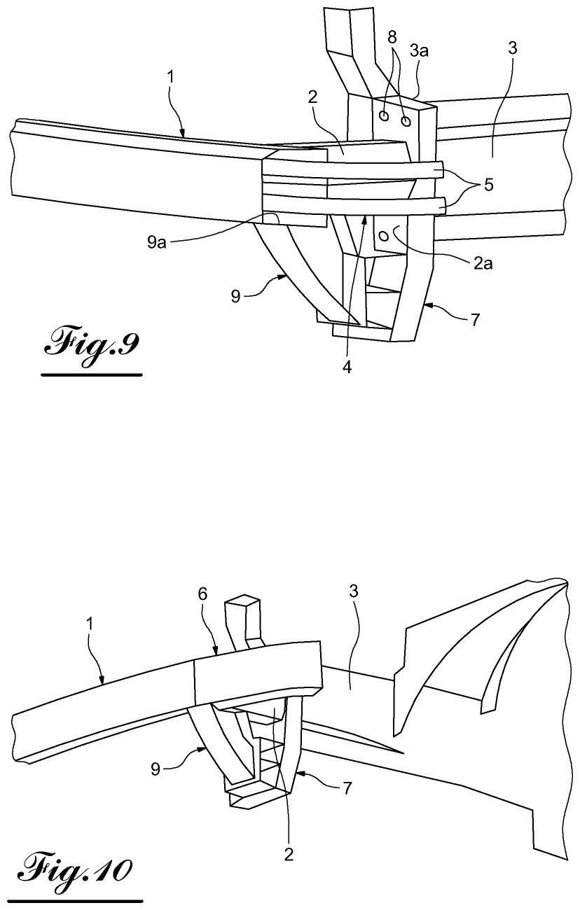

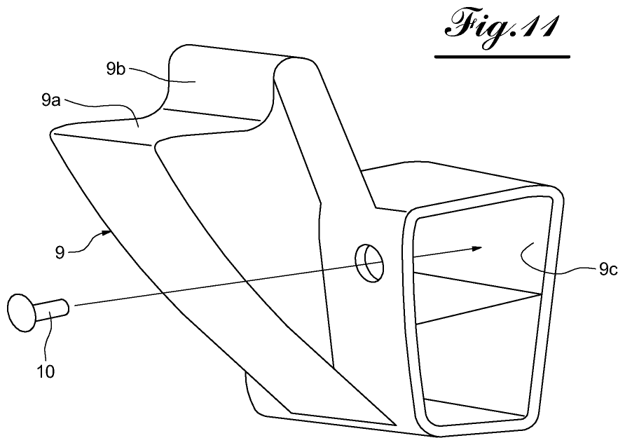

FIGS. 9 to 11 show an alternative embodiment that applies in the context of a gusset 7 front side sill 3 which is fastened between the two plates 2a, 3a respectively of each shock absorber 2 and the side sill 3 by means of fastening bolts 8.

Such a gusset 7 is mainly present in the case of a motor vehicle that has no lower track, but only an upper track comprising the two front side sills 3.

According to this embodiment, in addition to the presence of the reinforcing tip 4 with tubes 5 and the damping shell 6 at each end of the upper front beam 1, a box 9, preferably of composite material, is provided with internal partitions for reasons of inertia and lightening and which is mounted at a right angle between the metal gusset 7 and the upper front beam 1.

As best shown in FIG. 11, box 9 comprises a corner-forming top portion 9a that can be fastened by gluing under the lower flange of the upper front beam 1 and that is connected to an edge 9b substantially perpendicular to the corner 9a and adapted to abut against the beam 1 that is behind it during assembly before fastening the upper corner 9a under the flange of the beam 1.

Box 9 further comprises a bottom wall 9c which is fastened, for example by gluing, on the lower hanging part of the gusset 7 of the side sill 3. Alternatively, the bottom wall 9c can be fastened to the gusset 7 by self-tapping screws 10, only one of which is shown in FIG. 11.

Thus, even in the case of a motor vehicle with neither a lower track nor a lower beam, the addition of the box 9 between each gusset 7 and the high beam 1 makes it possible to increase the contact area with the deformable barrier B, as well as the stability of the beam 1, which is reinforced.

The vehicle front part described above has the following advantages:

it does not necessarily require the use of a new beam of the front part of the vehicle body and, therefore, does not involve additional investment, reducing manufacturing costs,

the high beam assembly, reinforcing tips with curved tubes and damping shells have a smaller mass than that of a reinforced beam of the prior art, about 0.5 kg less,

it fully meets the new European frontal impact protocol “frontal impact compatibility” due to the fact that each reinforcement tip does not present a risk of assaulting that would likely tear the deformable barrier B representing another vehicle and that the damping shell not only dampens and softens the contact of each end of the beam with the deformable barrier B, but also cancels any sharp edge of the metal parts to avoid tearing the deformable barrier,

it offers an improvement in front overhang of about 10 mm, which results in more freedom for the structures of front styles of motor vehicles;

the reinforcing tip of each end of the high front beam can be offered in various versions, that is to say it can be mounted or not, to each of the ends of this beam, depending on the geographical area of use of motor vehicles, which impose or not requirements that must comply with the new frontal impact protocol.

1. A front part of a vehicle body, comprises a transverse front bumper beam having two opposite ends each of which are connected to a front end of a shock absorber, a rear end of the shock absorber being connected to a front of one of two side sills of the body, wherein each end of the front beam comprises a rigid reinforcing tip integral with the front beam as an extension thereof; the reinforcing tip having a curvature directed towards a rear of the vehicle and in that the reinforcing tip is clad in a damping shell.

2. The front part of the vehicle body according to claim 1, wherein the reinforcing tip is fastened in a corresponding end part of the front beam by welding or gluing.

3. The front part of the vehicle body according to claim 1, wherein the reinforcing tip is fastened in a corresponding end part of the front beam by a foam expanded in this end part.

4. The front part of the vehicle body according to claim 1, wherein the damping shell is fastened by gluing around the reinforcing tip and, where appropriate, by gluing at its connection at the end of the front beam.

5. The front part of the vehicle body according to claim 1, wherein the reinforcing tip comprises two parallel and superimposed metallic tubes of circular or rectangular cross-section housed respectively in two internal compartments of the end part of the front beam.

6. The front part of the vehicle body according to claim 1, wherein the damping shell is a profile of a composite material.

7. The front part of the vehicle body according to claim 1, wherein the rear of each shock absorber has a plate which is itself fastened to a plate that is fastened to the front of the corresponding side sill, a gusset is fastened between the two plates and a box made of a composite material is fastened at a right angle between the gusset and the end of the front beam.
